(19) United States
(12) Patent Application Publication
(10) Pub. No.: US 2011/0074531 A1
(43) Pub. Date: Mar. 31, 2011

(54) ANISOTROPIC RARE EARTH-IRON BASED RESIN BONDED MAGNET

(75) Inventors: Fumitoshi YAMASHITA, Kitasaku-gun (JP); Osamu Yamada, Kitasaku-gun (JP); Shiho Ohya, Kitasaku-gun (JP)

(73) Assignee: MINEBEA CO., LTD., Kitasaku-gun (JP)

(21) Appl. No.: 12/853,601

(22) Filed: Aug. 10, 2010

(30) Foreign Application Priority Data
Sep. 29, 2009 (JP) 2009-223908

(51) Int. Cl. H01F 7/02

(52) U.S. Cl. 335/302

(57) ABSTRACT

Anisotropic rare earth-iron based resin bonded magnet comprises: [1] a continuous phase including: (1) a spherical Sm₂Fe₁₇N₃ based magnetic material covered with epoxy oligomer where its average particle size is 1 to 10 μm, its average aspect ratio ARₐᵥₑ is 0.8 or more, and mechanical milling is not applied after Sm—Fe alloy is nitrided; (2) a linear polymer with active hydrogen group reacting to the oligomer; and (3) additive; and [2] a discontinuous phase being an Nd₂Fe₁₄B based magnetic material coated with the epoxy oligomer where its average particle size is 50 to 150 μm, and its average aspect ratio ARₐᵥₑ is 0.65 or more, further satisfying: [3] the air-gap ratio of a granular compound on the phases is 5% or less; and [4] a composition where crosslinking agent with 10 μm or less is adhered on the granular compound is formed at 50 MPa or less.

### BACKGROUND OF THE INVENTION

1. Field of the Invention

The present invention relates to a rare earth-iron based resin bonded magnet, and more particularly to an anisotropic rare earth-iron based resin bonded magnet with high magnetic properties that will satisfy the following conditions: when coercivity HcJ at a room temperature is approximately 1 MA/m, a squareness at a room temperature is Hk/HcJ_{RT}, and a squareness at a temperature of 100° C. is Hk/HcJ₁₀₀, Expression Hk/HcJ_{RT}<k/HcJ₁₀₀ is obtainable. In this anisotropic rare earth-iron based resin bonded magnet, squareness deterioration based on a demagnetization curve at a high temperature can be avoided, and the maximum energy product (BH)ₘₐₓ can be 170 kJ/m³ or more.

2. Description of the Related Art

Material types for rare earth-iron based magnet such as Nd₂Fe₁₄B base, αFe/Nd₂Fe₁₄B base and Fe₃B/Nd₂Fe₁₄B base that are obtainable through rapid solidification, for example, a melt spinning method, are limited to a thin strip such as a ribbon, or powder obtained by milling the thin strip. Accordingly, for obtaining a bulked magnet applicable to a compact rotary machine, there will be necessary to conduct material transformation, that is, solidifying the thin strip or the powder into specific bulks with some measures. A primary measures to solidify the powder by means of powder metallurgy is pressureless sintering. However, it is not easy to apply the pressureless sintering to magnetic materials while maintaining their magnetic properties in a metastable condition. Based on the above, the thin strip or the powder has been solidified into specific bulks through binding materials such as epoxy resin, being able to obtain so-called resin bonded magnets.

For example, in 1985, R. W. Lee et al. reported that an isotropic Nd₂Fe₁₄B based bonded magnet with a (BH)ₘₐₓ of 72 kJ/m³ is obtainable in such a manner that a thin strip with a (BH)ₘₐₓ of 111 kJ/m³ is solidified with resin (see Non-Patent Document 1).

In 1986, the present inventors have proved through the Non-Patent Document 1 that an annular isotropic Nd₂Fe₁₄B magnet with a (BH)ₘₐₓ of up to 72 kJ/m³ where the thin strip is solidified with epoxy resin is practicable to compact rotary machines. Further, for example, in 1990, G. X. Huang et al. have proved practicability of an isotropic resin bonded magnet to compact rotary machines (see Non-Patent Document 2), and in the 1990's such a isotropic resin bonded magnet has been widely become known as an annular magnet for a high-performance compact rotor machine applicable to an electromagnetic driving device in electric and electronic equipment such as OA (office automation), AV (audio and visual), PC (personal computer), PC peripheral devices, and telecommunication equipment.

On the other hand, starting from the 1980's, extensive researches on magnetic materials in a melt spinning method have been conducted. Accordingly, Nd₂Fe₁₄B based materials, Sm₂Fe₁₇N₃ based materials, or nanocomposite materials through exchange coupling with αFe based or Fe₃B based materials based on the forenamed materials (Nd₂Fe₁₄B based and Sm₂Fe₁₇N₃ based materials) have become publicly known. Further, in addition to diversified alloy compositions or materials where the structure of the alloy compositions is subjected to fine-control, magnetic materials in different shapes obtainable by a rapid solidification method other than the melt spinning method became also known in recent (see for example, Non-Patent Documents 3 and 4). Also, Davies et al. reported magnetic materials where a (BH)ₘₐₓ is reachable up to 220 kJ/m³ even though the magnetic materials are isotropic (see Non-Patent Document 5). However, it is speculated that the (BH)ₘₐₓ of industrial applicable strips through the rapid solidification method is up to 134 kJ/m³, and the (BH)ₘₐₓ of an isotropic resin bonded magnet where the stripes are solidified with resin at 0.8 to 1.0 GPa can be estimated approximately up to 80 kJ/m³.

Regardless of the above, considering electromagnetic driving devices such as relatively compact rotary machines to which the present invention relates, along with the high performability of electrical and electric equipments, demands for further miniaturization, high-output and high efficiency have never been ceased. Thus, it is obvious that just improving the magnetic properties of magnetically isotropic strips through the rapid solidification method is no longer enough for catching up with the enhancing performance of electric and electronic equipment. Accordingly, necessity has been further focused on a magnet generating static magnetic fields in which to fit the most preferable magnetic circuits for the iron core of the rotary machines (preferably, magnets that generate further strong static magnetic fields per unit volume).

Here, considering Sm—Co based magnetic materials applied for a rare-earth magnet, it is possible to obtain high coercivity (HcJ) even though ingots have been milled. However, the application of Co has problems in its stable supply due to a fragile resource balance and so on. It would be thus not suitable to apply Co as general-purpose industrial materials. On the other hand, rare earth-iron based magnetic materials that are mostly based on Fe as well as rare-earth elements such as Nd, Pr and Sm are advantageous in stable resource supplies of a resource balance. However, only a limited HcJ is obtainable even if the ingots of Nd₂Fe₁₄B based alloy or sintering magnets are milled. Accordingly, for producing anisotropic Nd₂Fe₁₄B based magnetic materials, researches where melt spinning materials are applied as starting materials were advanced.

In 1989, Tokunaga obtained an anisotropic magnet with a (BH)ₘₐₓ of 127 kJ/m³ in such a manner as that a bulk where Nd₁₄Fe_{80-X}B₆Ga_{X} (X=0.4 to 0.5) is subjected to hot upsetting (die-upset) is milled so as to form anisotropic Nd₂Fe₁₄B based magnetic materials where HcJ=1.52 MA/m, and the magnetic materials are then solidified with resin (see Non-Patent Document 6). Also, in 1991, H. Sakamoto et al. obtained anisotropic Nd₂Fe₁₄B based magnetic materials where HcJ=1.30 MA/m in such a manner as that Nd₁₄Fe_{79.8}B_{5.2}Cu₁ is subjected to hot rolling (see Non-Patent Document 7). Accordingly, high HcJ (coercive) magnetic materials become publicly available while hot processing treatments are improved with addition of Ga and Cu, and the refinement of an Nd₂Fe₁₄B crystal particle size is further advanced.

In 1991, V. Panchanathan et al. obtained a resin bonded magnet with a (BH)ₘₐₓ of 150 kJ/m³ through a hot mill method, specifically as that the invasion of hydrogen is made from a grain boundary so as to make a bulk collapsed as Nd₂Fe₁₄BH_{X}, and then HD (hydrogen decrepitation)—Nd₂Fe₁₄B magnetic materials that have been dehydrogenated by vacuum heating are extracted. Finally, the magnetic materials are solidified by resin (see Non-Patent Document 8). In 2001, through the same method, Iriyama obtained a modified anisotropic magnet with a (BH)ₘₐₓ of 177 kJ/m³ by making Nd_{0.137}Fe_{0.735}CO_{0.067}B₀₀₅₅Ga_{0.006} into magnetic materials and then solidified with resin (see Non-Patent Document 9).

Then, in 1999, a resin bonded magnet with a (BH)ₘₐₓ of 193 kJ/m³ is obtained in such a manner that an Nd—Fe(Co)—B ingot is heat-treated in hydrogen atmosphere such that: Nd₂(Fe, Co)₁₄B phase is hydrogenated (hydrogenation, Nd₂(Fe, Co)₁₄BH_{X}); the phase is decomposed at 650 to 1000° C. (decomposition, NdH₂+Fe+Fe₂B); hydrogen is desorbed (desorption); and recombination is performed (recombination). Finally, HDDR Nd₂Fe₁₄B based magnetic materials are solidified with resin at 1 GPa (see Non-Patent Document 10).

In 2001, Mishima et al. reported Co-free d-HDDR Nd₂Fe₁₄B based magnetic materials (see Non-Patent Document 11), and N. Hamada et al. obtained a cubic anisotropic magnet (7 mm×7 mm×7 mm) with a density of 6.51 Mg/m³ and a (BH)ₘₐₓ of 213 kJ/m³ in such a manner that d-HDDR Nd₂Fe₁₄B based magnetic materials with a (BH)ₘₐₓ of 358 kJ/m³ are compressed together with resin at 0.9 GPa and at temperature of 150° C. in orientation magnetic field of 2.5 T (see Non-Patent Document 12).

### Patent Document

<Patent Document 1> Patent Application No. Sho 61-38830

### Non-Patent Documents

<Non-Patent Document 1> R. W. Lee, E. G Brewer, N. A. Schaffel, “PROCESSING OF NEODYMIUM-IRON-BORON MELT-SPUN RIBBONS TO FULLY DENSE MAGNETS” IEEE Trans. Magn., Vol. 21, 1985
<Non-Patent Document 2> G. X. Huang, W. M. Gao, S. F. Yu, “Application of Melt-spun Nd—Fe—B Bonded magnet to the Micromotor”, Proc. of the 11th International Rare-Earth Magnets and Their Applications, Pittsburgh, USA, pp. 583-594 (1990)<
<Non-Patent Document 3> B. H. Rabin, B. M. Ma, “Recent developments in NdFeB Powder”, 120th Topical Symposium of the Magnetics Society of Japan, pp. 23-30 (2001)<
<Non-Patent Document 4> S. Hirosawa, H. Kanekiyo, T. Miyoshi, K. Murakami, Y. Shigemoto, T. Nishiuchi, “Structure and Magnetic properties of Nd₂Fe₁₄B/Fe_{X}B-type nanocomposites prepared by Strip casting”, 9th Joint MMM/INTERMAG, CA (2004) FG-05
<Non-Patent Document 5> H. A. Davies, J. I. Betancourt R. and C. L. Harland, “Nanophase Pr and Nd/Pr-based Rare Earth-Iron-Boron Alloys”, Proc. of 16th Int. Workshop on Rare-Earth Magnets and Their Applications, Sendai, pp. 485-495 (2000)<
<Non-Patent Document 6> G. Tokunaga, “Magnetic Characteristic of Rare-Earth Bond Magnets, Magnetic Powder and Powder Metallurgy”, Vol. 35, pp. 3-7 (1988)<
<Non-Patent Document 7> T. Mukai, Y. Okazaki, H. Sakamoto, M. Fujikura and T. Inaguma, “Fully-dense Nd—Fe—B Magnets prepared from hot-rolled anisotropic powders”, Proc. 11th Int. Workshop on Rare-Earth Magnets and Their Applications, Pittsburgh, pp. 72-84 (1990)<
<Non-Patent Document 8> M. Doser, V. Panchanacthan, and R. K. Mishra, “Pulverizing anisotropic rapidly solidified Nd—Fe—B materials for bonded magnets”, J. Appl. Phys., Vol. 70, pp. 6603-6605 (1991)<
<Non-Patent Document 9> T. Iriyama, “Anisotropic bonded NdFeB magnets made from Hot-upset powders”, Polymer Bonded Magnet 2002, Chicago (2002)<
<Non-Patent Document 10> K. Morimoto, R. Nakayama, K. Mori, K. Igarashi, Y. Ishii, M. Itakura, N. Kuwano, K. Oki, “Anisotropic Nd₂Fe₁₄B-based Magnet powder with High remanence produced by Modified HDDR process”, IEEE. Tran. Magn., Vol. 35, pp. 3253-3255 (1999)<
<Non-Patent Document 11> C. Mishima, N, Hamada, H. Mitarai, and Y. Honkura, “Development of a Co-free NdFeB Anisotropic bonded magnet produced from the d-HDDR Processed powder”, IEEE. Trans. Magn., Vol, 37, pp. 2467-2470 (2001)
<Non-Patent Document 12> N. Hamada, C. Mishima, H. Mitarai and Y. Honkura, “Development of Nd—Fe—B Anisotropic Bonded Magnet with 27 MGOe” IEEE. Trans. Magn., Vol. 39, pp. 2953-2955 (2003)<
<Non-Patent Document 13> Z. Chena, Y. Q. Wub, M. J. Kramerb, B. R. Smith, B. M. Ma, M. Q. Huang, “A study on the role of Nb in melt-spun nanocrystalline Nd—Fe—B magnets', J., Magnetism and Magn., Mater., 268. pp. 105-113 (2004)”

Considering resin bonded magnets where the above descried anisotropic rare earth-iron based magnetic materials are solidified with resin at 0.9 GPa, for example, it is possible to gain the magnetic property of a (BH)ₘₐₓ that is more than as twice as an isotropic resin bonded magnet with 80 kJ/m³. However, for adapting the anisotropic resin bonded magnets to rotary machines, it would be necessary to satisfy magnetic stability such as demagnetizing strength against irreversible demagnetization or demagnetizing fields.

Here, compared to the grain size 15-20 nm of an isotropic Nd₂Fe₁₄B based magnetic material obtained through a rapid-solidified thin strip (for example, see Non-Patent Document 13), an anisotropic Nd₂Fe₁₄B based magnetic material obtained through either the milling of hot-worked bulks or HDDR treatments has the grain size of 200 to 500 nm which is the texture of a Nd₂Fe₁₄B crystal that is one digit larger than the isotropic Nd₂Fe₁₄B based magnetic materials.

In case that the grain size of Nd₂Fe₁₄B is, for example, 15 to 20 nm, magnetic properties (including magnetic stability), such as remanence Mrₚ based on remanence enhancement effects or temperature coefficient βₚ%/° C. of coercivity HcJp, are improved. In addition, the magnetic properties such as HcJₚ or (BH)ₘₐₓₚ of the magnetic materials would be not prominently deteriorated even if the particle size becomes lessened approximately to, for example, 40 μm.

That is, in case that the grain size of Nd₂Fe₁₄B is, for example, 15 to 20 nm, at the stage where the materials are compressed with resin, for example, at 0.8 to 1.0 GPa so as to obtain resin bonded magnets in a specific form, it would be inevitable that the surface of the magnetic material are damaged or fractured. However, the magnetic property deterioration of the magnetic materials is within a range that can be actually ignored.

Here, when considering Nd₂Fe₁₄B based magnetic materials where hot-worked bulks with a Nd₂Fe₁₄B grain size of 200 to 500 nm are milled, or anisotropic resin bonded magnets where HDDR-Nd₂Fe₁₄B based magnetic materials are solidified with resin at 0.8 to 1.0 GPa, occurrence of newly created surfaces or microcracks would be inevitable due to the damage or breakage of the surface of magnetic materials through densification. Accordingly, Nd₂Fe₁₄B crystals formed on the most outer surface of the magnetic materials are oxidized so as to cause texture evolution, whereby magnetic properties based on HcJₚ, (BH)ₘₐₓₚ, etc. may be deteriorated. The treatment deterioration of the magnetic properties of the anisotropic Nd₂Fe₁₄B based magnetic materials is obvious compared to the isotropic Nd₂Fe₁₄B based magnetic materials. Thus, in order to suppress the deterioration of the magnetic properties occurring when the anisotropic Nd₂Fe₁₄B based magnetic materials are densified, it would be necessary to reduce or modify pressures toward the magnetic materials through the densification.

On the other hand, considering magnetic materials that have a nucleation-typed coercive generation mechanism which is typical in SmCo_{S} base or Sm₂Fe₁₇N₃ base, they generally need a particle size of 10 μm or less. As to resin bonded magnets where these magnetic materials with such a small particle size are compressed with resin, it would be difficult to make their densities to be 5 Mg/m³ or more (relative density: 65%). Accordingly, these resin bonded magnets are generally used as an injection-molded resin bonded magnet. Therefore, compared to an isotropic Nd₂Fe₁₄B based resin bonded magnet with a (BH)ₘₐₓ of approximately 80 kJ/m³ where an isotropic Nd₂Fe₁₄B based magnetic materials are milled and solidified with resin at 0.8 to 1 GPa, the advantage of (BH)ₘₐₓ is far behind, largely lowered than the (BH)ₘₐₓ of an anisotropic Nd₂Fe₁₄B based resin bonded magnet.

It can be therefore said that these technical problems discussed hereinabove could be one of the factors which hampers an anisotropic rare earth-iron based resin bonded magnet from being applied to electromagnetic driving devices such as rotary machines although the anisotropic rare earth-iron based resin bonded magnet is regarded as the next generation type of the isotropic Nd₂Fe₁₄B based resin bonded magnet with a (BH)ₘₐₓ of 80 kJ/m³.

### SUMMARY OF THE INVENTION

The present invention has been made in view of the circumstances described above, and it is an object of the present invention to provide an anisotropic rare earth-iron based resin bonded magnet that can be a next generation type for isotropic Nd₂Fe₁₄B based resin bonded magnets with (BH)ₘₐₓ of 80 kJ/m³, contributing to miniaturization and a high mechanical output power of rotary machines.

In order to achieve the object described above, according to an aspect of the present invention, there is provided an anisotropic rare earth-iron based resin bonded magnet comprising:

[1] a continuous phase including: (1) a spherical Sm₂Fe₁₇N₃ based magnetic material where its average particle size is 1 to 10 μm, its average aspect ratio ARₐᵥₑ is 0.8 or more in a condition that AR is b/a when the maximum diameter of a particulate picture is “a” while the maximum diameter perpendicular to the “a” is “b”, and mechanical mining is not applied after an Sm—Fe alloy is nitrided, the spherical Sm₂Fe₁₇N₃ based magnetic material being covered with solid epoxy oligomer at a room temperature; (2) a linear polymer that has an active hydrogen group in which to react to the oligomer; and (3) an additive to be added in when necessary; and

[2] a discontinuous phase being defined by an Nd₂Fe₁₄B based magnetic material where its average particle size is 50 to 150 μm, and its average aspect ratio ARₐᵥₑ is 0.65 or more, the Nd₂Fe₄B based magnetic material being covered with solid epoxy oligomer at a room temperature, the anisotropic rare earth-iron based resin bonded magnet further satisfying the following:

[3] an air-gap ratio of a granular compound on the continuous and discontinuous phases is 5% or less; and

[4] a composition where a crosslinking agent having an average particle size of 10 μm or less is adhered on a surface of the granular compound is formed into a predetermined shape through a magnetic field press at 50 MPa or less.

In an anisotropic rare earth-iron based resin bonded magnet according to the present invention, for improving magnetic stability such as irreversible demagnetization or demagnetizing proof stress against reverse magnetic fields at a high temperature, and magnetic properties typically defined by a (BH)ₘₐₓ, the following conditions should be established. When the coercivity of Sm₂Fe₁₇N₃ based magnetic materials is set to HcJp_{S}, the coercivity of Nd₂Fe₁₄B based magnetic materials at a room temperature is set to HcJp_{N}, and a ratio between HcJp_{S} and HcJp_{N} (HcJp_{S}/HcJp_{N}) is set to α, HcJp_{N} is 1 to 1.25 MA/m, and HcJp_{S} is equal to or less than HcJp_{N} (HcJp_{S}<HcJp_{N}). Further, a should be 0.75 or less, or more preferably 0.65 or less.

Based on the above, according to the present invention, when the remanence of the anisotropic rare earth-iron based resin bonded magnet is set to Mrₘ, the remanence of a mixing body defined by spherical Sm₂Fe₁₇N₃ based magnetic materials and Nd₂Fe₁₄B based magnetic materials is set to Mrₚ, and the volume fraction of the whole magnetic materials accounting for the resin bonded magnet is set to Vfₚ, it is possible that the orientation degree Mr_{M}/(Mrₚ×Vfₚ) of the magnetic materials can be set to 0.96 or more, and a (BH)ₘₐₓ can be set to 170 kJ/m³ or more in a condition that α is 0.75 or less, and Vfₚ is equal to or greater than 80 vol. % (Vfₚ≧80 vol. %). Further, in a condition that α is 0.65 or less, and Vfₚ is equal to or greater than 80 vol. % (Vfₚ≧80 vol. %), the orientation degree Mr_{M}/(Mrₚ×Vfₚ) can be set to 0.98 or more, and a (BH)ₘₐₓ can be set to 180 kJ/m³ or more.

Moreover, in case that the squareness of a demagnetization curve of the anisotropic rare earth-iron based resin bonded magnet at a room temperature according to the present invention is set to Hk/HcJ_{RT}, and squareness at 100° C. is set to Hk/HcJ₁₀₀, it is preferable to establish that Hk/HcJ_{RT} is less than Hk/HcJ₁₀₀ (Hk/HcJ_{RT}<Hk/HcJ₁₀₀).

In the anisotropic rare earth-iron based resin bonded magnet according to the present invention, when considering the structure of rotary machines that can effectively secure magnetic stability and can employ air-gap magnetic flux density between a magnet and an iron core (that is, a magnetic circuit structure between the iron core and the magnet), it is preferable to establish that permeance coefficient Pc is 3 or more.

As discussed hereinabove, the anisotropic rare earth-iron based resin bonded magnet according to the present invention can be structured as that the squareness of the demagnetization curve at a high temperature based on Hk/HcJ_{RT}<Hk/HcJ₁₀₀ is not deteriorated. Further, since the anisotropic rare earth-iron based resin bonded magnet according to the present invention also has high magnetic properties where the maximum energy product (BH)ₘₐₓ is 170, or more than 180 kJ/m³, it would be applicable as the next generation type of an isotropic Nd₂Fe₁₄B based resin bonded magnet with a (BH)ₘₐₓ of 80 kJ/m³, contributing to make the rotary machines to be further miniaturized and to have higher mechanical output.

A resin bonded magnet satisfying the following conditions is going to be considered:

<1> A continuous phase is composed of: (1) a spherical Sm₂Fe₁₇N₃ based magnetic material that has an average aspect ratio ARₐᵥₑ of 0.80 or more and is covered with epoxy oligomer; (2) a linear polymer having an active hydrogen reactive group that can react to the oligomer; and (3) an additive to be properly added when necessary;

<2> a discontinuous phase is Nd₂Fe₁₄B based magnetic materials that are covered with epoxy oligomer;

<3> the air-gap ratio of a granular compound existed in the continuous and discontinuous phases is set to 5% or less; and

<4> a composition, in which crosslinking agents made of impalpable powder are adhered on the surface of the granular compound, is produced through a magnetic field pressing at 50 MPa or less.

In the above conditions, when the coercivity of Sm₂Fe₁₇N₃ based components is set to HcJp_{S}, the coercivity of Nd₂Fe₁₄B based components is set to HcJp_{N}, and their ratio (HcJp_{S}/HcJp_{N}) is set to α, HcJp_{N} can be set to 1 to 1.25 MA/m while HcJp_{S} can be equal to or less than HcJp_{N} (HcJp_{S}≦HcJp_{N}). Further, in case that the remanence of resin bonded magnets is set to Mr_{M}, the remanence of magnetic materials is set to Mrₚ, and the volume fraction of the magnetic materials is set to Vfₚ, the following is established: Vfₚ is equal to or greater than 80 vol. % (Vfₚ≧80 vol. %), Mr_{M}/(Mrₚ×Vfₚ) is 0.96 or more where α is 0.75 or less, and a (BH)ₘₐₓ is 170 kJ/m³ or more. Still further, when Vfₚ is equal to or greater than 80 vol. % (Vfₚ≧80 vol. %), and α is 0.65 or less, the following is established: Mr_{M}/(Mrₚ×Vfₚ) is 0.98 or more, and a (BH)ₘₐₓ is 180 kJ/m³ or more. In addition, when the squareness of the resin bonded magnets at a room temperature is set to Hk/HcJ_{RT}, and the squareness at a temperature of 100° C. is set to Hk/HcJ₁₀₀, it is possible to establish that Hk/HcJ_{RT} is less than Hk/HcJ₁₀₀(Hk/HcJ_{RT}<Hk/HcJ₁₀₀).

As discussed hereinabove, in an anisotropic rare earth-iron based resin bonded magnet according to the present invention, when the coercivity HcJ at a room temperature is approximately 1 MA/m or more, the squareness at a room temperature is Hk/HcJ_{RT}, and the squareness at a temperature of 100° C. is Hk/HcJ₁₀₀, Hk/HcJ_{RT} will be less than Hk/HcJ₁₀₀ (Hk/HcJ_{RT}<Hk/HcJ₁₀₀). Accordingly, the squareness of demagnetization curve will not be deteriorated at a high temperature, magnetic stability can be well secured, and the maximum energy product (BH)ₘₐₓ can be 170 kJ/m³ or more. Here, when considering rotary machines (meaning a magnetic circuit structure between an iron core and a magnet) that can effectively secure the magnetic stability and can employ the air-gap magnetic flux density of the anisotropic rare earth-iron based resin bonded magnet according to the present invention, it is preferable that permeance coefficient Pc is 3 or more.

### BRIEF DESCRIPTION OF THE DRAWINGS

FIG. 1 is a chart indicating a relation between the coercivity HcJp_{N} and (BH)_{maxPN} of an Nd₂Fe₁₄B based magnetic materials;

FIG. 2 is a chart indicating the X-ray diffraction pattern of an Sm₂Fe₁₇N₃ based magnetic materials;

FIGS. 3A and 3B are expanded views indicating two kinds of Sm₂Fe₁₇N₃ based magnetic materials;

FIG. 4 is a chart indicating a relation between the particle size and the aspect ratio AR of the Sm₂Fe₁₇N₃ based magnetic materials;

FIGS. 5A and 5B are expanded views indicating two kinds of the Nd₂Fe₁₄B based magnetic materials;

FIGS. 6A and 6B are charts indicating the torsion torque behavior of melt-blending materials;

FIGS. 7A and 7B are charts indicating the torsion torque behavior of a composition including a crosslinking agent;

FIGS. 8A and 8B are charts indicating a relation between the coercivity of spherical Sm₂Fe₁₇N₃ based magnetic materials and the squareness Hk/HcJ of a magnet;

FIGS. 9A and 9B are charts indicating relations of: HcJp_{S} and Mr_{M}/(Mrₚ×Vfₚ); a; and Mr_{M}/(Mrₚ<Vfₚ) and the (BH)ₘₐₓ of a magnet;

FIG. 10 is a chart indicating a relation between Hk/HcJ_{RT} and Hk/HcJ₁₀₀; and

FIGS. 11A and 11B are charts indicating a demagnetization curve and the permeance dependence of the gain ratio of magnetic flux density.

### DETAILED DESCRIPTION OF THE INVENTION

First, in terms of a continuous phase according to the present invention, spherical Sm₂Fe₁₇N₃ based magnetic materials will be explained hereinafter. The spherical Sm₂Fe₁₇N₃ based magnetic materials satisfy the following condition as that: its average particle size is 1 to 10 μm, its average aspect ratio ARₐᵥₑ is 0.80 or more; and mechanical milling is not conducted following the nitriding of Sm—Fe alloy. Further, the above spherical Sm₂Fe₁₇N₃ based magnetic materials are covered with solid epoxy oligomer at a room temperature.

The Sm₂Fe₁₇N₃ based magnetic materials may be formed with the following method: a melt casting method disclosed by Japanese Patent Application Laid-Open No Hei 2-57663, or a reduction/diffusion method disclosed by Japanese Patent No. 17025441 or Japanese Patent Application Laid-Open No. Hei 9-157803. These methods are performed as that: an Sm—Fe based alloy or an Sm—(Fe, Co) based alloy is produced; and the alloy is nitrided and then mechanically milled so as to be reduced into a particle size.

Considering the spherical Sm₂Fe₁₇N₃ based magnetic material where its average particle size is 1 to 10 μm, and its average aspect ratio ARₐᵥₑ is 0.80 or more, after an Sm₂Fe₁₇ alloy is nitrided, mechanical milling means such as jet mill, vibration ball mill or rotation ball mill are not conducted. This is due to a reason that micronized powder, which is inevitably produced through mechanical milling, will never exist.

As to a specific method that can produce the Sm₂Fe₁₇N₃ based magnetic materials where the mechanical milling means is not applied following the nitriding of the Sm₂Fe₁₇ alloy, the following method can be introduced: impalpable powder such as an Sm—Fe based alloy or an Sm—(Fe, Co) based alloy is produced based on a molten alloy through a gas-atomized method, and then the impalpable powder is nitrided. Accordingly, without conducting the mechanical milling following nitriding, it is possible to obtain the Sm₂Fe₁₇N₃ based magnetic materials according to the present invention.

Further, as shown in Japanese Patent Application Laid-Open No. Hei 6-1151127, it is possible to obtain the Sm₂Fe₁₇N₃ based magnetic material according to the present invention which is not necessary for mechanical milling following nitriding in such a manner that carbonyl iron is applied, and the temperature of the reduction/diffusion method used for the reduction of an rare-earth element is set within 650 to 880° C.

Still further, in Japanese Patent Application Laid-Open No. Hei 11-335702, for example, Sm₂O₃ with an average particle size of 35 μm and Fe₂O₃ with an average particle size of 1.3 μm are mixed with Sm (11% at atomic percent) and Fe (89.0% at atomic percent), and then milled and blended through wet milling to obtain dried, blended powder. The blended powder is then preheated at 600° C. in hydrogen flow for 4 hours so as to reduce the iron oxide into metals with an average particle size of 2 to 3 μm. The reduced blended powder is then mixed with Ca particles and heated at 1000° C. in an Ar atmosphere for one hour. After conducting the diffusion/reduction treatments, nitriding at 450° C. for 2 hours is performed. Lastly, rinsing and dehydrated drying are performed. Accordingly, the Sm₂Fe₁₇N₃ based magnetic material can be obtained without conducting mechanical milling following nitriding.

In addition, Japanese Patent Application Laid-Open No. 2004-115921 discloses a sol-gel method enabling to obtain the Sm₂Fe₁₇N₃ based magnetic material without conducting mechanical milling. In the sol-gel method, Sm and Fe are dissolved in acid, and materials generating salt that is insoluble in Sm ion and Fe ion are precipitated through solution reaction. The precipitated materials are then calcined so as to obtain metallic oxide.

Still further, Japanese Patent Application Laid-Open No. 2004-115921 also discloses the sol-gel method. In the method, Sm and Fe, are dissolved in acid, and materials that produce salt insoluble in Sm ion and Fe ion are precipitated through a solution reaction. The precipitated materials are then calcined producing metallic oxide. For example, from Sm ion or Fe ion solution, materials that produce salt insoluble in the metallic ion will be supplied. Oxalic acid may be supplied as a material that provides hydroxide ion. In these organic solvents of metal alkoxide, addition of water can separate out metal hydroxide, the metal hydroxide being precipitated. The metallic oxide obtained as discussed above is then reduced so as to obtain fine Sm₂Fe₁₇ alloy powder which is then nitrided. Based on the above, it is possible to obtain the Sm₂Fe₁₇N₃ based magnetic materials without conducting mechanical milling.

Accordingly, the present invention can provide the spherical Sm₂Fe₁₇N₃ based magnetic material where, among the Sm₂Fe₁₇N₃ based magnetic materials that are produced without mechanical milling after nitriding Sm—Fe alloy, its average particle size is 1 to 10 μm, and its average aspect ratio ARₐᵥₑ is 0.80 or more. With the spherical Sm₂Fe₁₇N₃ based magnetic materials, it would be possible to eliminate micronized powder that is inevitably produced by mechanical milling.

Here, in the present invention, the micronized powder means a particle size less than 1 μm (exclusive). As disclosed in Japanese Patent Application Laid-Open No. 2000-12316, the micronized powder of this size will negatively influence the magnetic properties of the Sm₂Fe₁₇N₃ based magnetic material. However, by applying a temperature history of 50° C. or more that will be necessary for resin bonded magnets to be a specific form, the micronized powder with a particle size less than 1 μm (exclusive) will be disappeared. Accordingly, only the Sm₂Fe₁₇N₃ based magnetic material with a particle size of 1 μm or more (providing no negative influence) will exist and satisfactorily deal with the determined magnetic properties of the resin bonded magnet.

In the spherical Sm₂Fe₁₇N₃ based magnetic material according to the present invention, it would be possible to have multiple surface treatments (more than one time). Specifically, the surface formation of a de-oxidation film is disclosed by Japanese Patent Publication Laid-Open No. Sho 52-54998, Japanese Patent Publication Laid-Open No. Sho 59-170201, Japanese Patent Publication Laid-Open No. Sho 60-128202, Japanese Patent Publication Laid-Open No. Hei 3-211203, Japanese Patent Publication Laid-Open No. Sho 46-7153, Japanese Patent Publication Laid-Open No. Sho 56-55503, Japanese Patent Publication Laid-Open No. Sho 61-154112, Japanese Patent Publication Laid-Open No, Hei 3-126801, etc. Further, the surface formation of a metallic film is disclosed by Japanese Patent Publication Laid-Open No. Hei 5-230501, Japanese Patent Publication Laid-Open No. Hei 5-234729, Japanese Patent Publication Laid-Open No. Hei 8-143913, Japanese Patent Publication Laid-Open No. Hei 7-268632, etc. Still further, the surface formation of an inorganic film is disclosed by Examined Patent Publication No. Hei 6-17015, Japanese Patent Publication Laid-Open No. Hei 1-234502, Japanese Patent Publication Laid-Open No. Hei 4-217024, Japanese Patent Publication Laid-Open No. Hei 5-213601, Japanese Patent Publication Laid-Open No. Hei 7-326508, Japanese Patent Publication Laid-Open No. Her 8-153613, Japanese Patent Publication Laid-Open No. Hei 8-183601, etc.

Here, in the spherical Sm₂Fe₁₇N₃ based magnetic material according to the present invention where no mechanical milling means is applied following nitriding, it would be necessary to have a solid epoxy oligomer layer on the most outer surface thereof at a room temperature. As to the preferable example of the epoxy oligomer, an o-cresol novolac epoxy oligomer can be, for example, named where epoxy equivalent is 205 to 220 g/eq, a melting point is 70 to 76° C., and the suitable thickness of the layer is 30 to 100 nm. Here, if the thickness of the layer is less than 30 nm (exclusive), the fixing strength of the spherical Sm₂Fe₁₇N₃ based magnetic material will be decreased. On the other hand, if 100 nm or more, a (BH)ₘₐₓ will be decreased along with the increase of the volume fraction of non-magnetic materials.

Next, a continuous phase according to the present invention that is composed of: a linear polymer having active hydrogen groups that may react to a sold epoxy oligomer coated on the spherical Sm₂Fe₁₇N₃ based magnetic material at a room temperature; and an additive which is added in when necessary will be hereinafter explained.

Considering the linear polymer constructing the continuous phase of the present invention, for example, a polyamide-12 where a number-average molecular weight Mn is 4000 to 12000 or its copolymer can be named. Further, as to the additive which is properly added in when necessary, the following are preferably named as internal lubricant: a hydrophilic functional group that accelerates external elusion from a molten linear polymer when the magnetic materials are densified; and organic compounds where at least one long-chain alkyl group for producing internal lubricating effects is included per molecule and a melting point is approximately 50° C. or more. Specifically, one hydroxyl group (—OH) per molecule, or organic compounds with 3 heptadecyl groups (—(CH₂)₁₆—CH₃) of carbon number 17 may be exemplified.

Next, an Nd₂Fe₁₄B based magnetic material where its discontinuous phase is coated with a solid epoxy oligomer at a room temperature, its average particle size is 50 to 150 μM, and its average aspect ratio ARₐᵥₑ 0.65 or more will be explained. Further, the reason that the air-gap ratio of a granular compound on the continuous and discontinuous phases is set to 5% or less will be also explained.

The Nd₂Fe₁₄B based magnetic material according to the present invention where its average particle size 50 to 150 μm while its average aspect ratio ARₐᵥₑ is 0.65 or more may suitably be a so-called Hydrogenation, Disproportionation, De-sorption, and Re-combination HDDR-N₂Fe₁₄B based magnetic materials or Co-free d-HDDR-R₂Fe₁₄B based magnetic materials, these magnetic materials being disclosed by Japanese Patent No. 3092672, Japanese Patent No. 2881409, Japanese Patent No. 3250551, Japanese Patent No. 3410171, Japanese Patent No. 3463911, Japanese Patent No. 3522207, Japanese Patent No. 3595064, etc. The HDDR discussed hereinabove is performed as that: R₂(Fe, Co)₁₄B based alloy (R is Nd, Pr) is hydrogenated (Hydrogenation, R₂(Fe, Co)₁₄B Hx), a phase decomposition is performed at a temperature of 650 to 1000° C. (Decomposition, RH₂+Fe+Fe₂B), dehydrogenation is performed (Desorption), and recombination is finally performed (Recombination). Here, as disclosed by Japanese Patent Publication Laid-Open No, 2004-266093, Japanese Patent Publication Laid-Open No. 2005-26663, Japanese Patent Publication Laid-Open No, 2006-100560, etc., it could be alternated by the magnetic materials that have predetermined surface treatments.

Considering the Nd₂Fe₁₄B based magnetic materials where hot-working bulks are milled by means of a mechanical means, an anisotropic Nd₂Fe₁₄B grain is flat, and the materials that are mechanically milled can be structured in many cases that its thickness direction is correspondent with a C axial direction. That is, the magnetic material will have a shape magnetic anisotropy that is perpendicular to the C axis whereby it would be difficult to obtain the average particle size of 50 to 150 μm, and the average aspect ratio Alₐᵥₑ of 0.65 or more.

As discussed, the Nd₂Fe₁₄B based magnetic material according to the present invention where its average particle size is 50 to 150 μm, and its average aspect ratio ARₐᵥₑ is 0.65 or more will need to have a solid epoxy oligomer at a room temperature that is coated on the most outer surface thereof. Here, it would be preferable that the coated layer is approximately 30 to 100 nm. Here, if the thickness of the coated layer is less than 30 nm (exclusive), the fixing strength of the spherical Sm₂Fe₁₇N₃ based magnetic material will be decreased. On the other hand, if 100 nm or more, magnetization and a (BH)ₘₐₓ will be decreased along with increase of the volume fraction of non-magnetic materials.

As discussed, in the present invention,

<1> a continuous phase includes: (1) a spherical Sm₂Fe₁₇N₃ based magnetic material where its average particle size is 1 to 10 μm, its average aspect ratio ARₐᵥₑ is 0.8 or more, and mechanical milling is not applied after an Sm—Fe alloy is nitrided, the spherical Sm₂Fe₁₇N₃ based magnetic material being covered with epoxy oligomer that is solid at a room temperature; (2) a linear polymer that has an active hydrogen group in which to react to the oligomer; and (3) an additive to be added in when necessary;

<2> a discontinuous phase includes an Nd₂Fe₁₄B based magnetic material where its average particle size is 50 to 150 μm, and its average aspect ratio ARₐᵥₑ is 0.65 or more, the Nd₂Fe₁₄B based magnetic material being covered with epoxy oligomer that is solid at a room temperature:

<3> the air-gap ratio of a granular compound on the continuous and discontinuous phases is 5% or less;

<4> the particle size of the compound is 1 mm or less; and

<5> a composition where the crosslinking agent of an impalpable powder is physically adhered on the surface of the granular compound is formed into a predetermined shape through a magnetic field press at 50 MPa or less.

The following methods can be considered as a specific means that the air-gap ratio for the granular compound on the continuous and discontinuous phases can be 5% or less. That is, the mixtures of the continuous and discontinuous phases are mixed by means of a mixing roll at least in a molten linear polymer. The mixed materials that have been cooled down to a room temperature are then shredded so as to obtain granular compound with a particle size of at least 1 mm or less. Aim to make the mixed materials to have the particle size of 1 mm or less is to provide powder flowability. Here, if the particle size is 1 mm or less, there is no obstruction of making magnetic materials to be arranged in the magnetic fields in a melting condition of the linear polymer. Note that if the particle size becomes greater than 1 mm (exclusive), a crosslinking reaction between the granular compound and crosslinking agents of impalpable powder that have been physically adhered on the surface of the granular compound will become heterogeneity. Accordingly, that causes mechanical deficiencies of the resin bonded magnet along with strength deterioration.

By performing the above described mixing in a molten linear polymer, it is possible to set the air-gap ratio of the granular compound to be 5% or less. Here, it should be emphasized that it is possible to obtain the anisotropic rare earth-iron based resin bonded magnet according to the present invention with the air-gap ratio of 5% or less at an extremely low temperature of 50 MPa or less.

As a crosslinking agent according to the present invention, a so-called latent crosslinking agent can be suitably exemplified, the latent crosslinking agent being, for example, an imidazole adduct (2-phenyl-4,5-dihydroxymethylimidazole) with a thermal decomposition temperature of 230° C. where its average particle size is approximately 5 μm.

Next, in the present invention, in order to obtain the magnetic stability of the anisotropic rare earth-iron based resin bonded magnet, the following conditions should be established. That is, when the coercivity of Sm₂Fe₁₇N₃ based magnetic material at a room temperature is HcJp_{S}, the coercivity of Nd₂Fe₁₄B based magnetic material is HcJp_{N}, and a ratio between HcJp_{S} and HcJp_{N} (HcJp_{S}/HcJp_{N}) is α, HcJp_{N} will be 1 to 1.25 MA/m. Further details are explained hereinbelow.

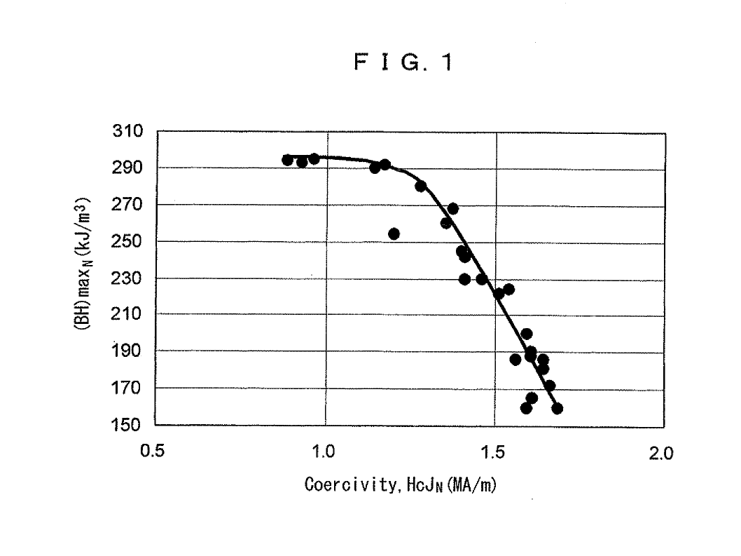

A relation between the coercivity of Nd₂Fe₁₄B based magnetic material (for example, an alloy composition Nd_{12.3-7 6}Dy_{0.3-50}Fe_{64.6}CO_{12.3}B_{6.0}Ga_{0.6}Zr_{0.1}) at a room temperature and its (BH)_{maxPN} can be defined to have a certain tendency as shown in FIG. 1. As clearly shown in the FIG., it is possible to enhance HcJp_{N} by improving an anisotropic magnetic field Ha by Dy. However, in this case, if value exceeds 1.25 MA/m, the decrease of (BH)_{maxPN} will be accelerated. In this regard, it is true that the crystal grain HcJp_{N} will increase while a part of the crystal grain Ha is increased according to Dy substitution. On the other hand, as to a large number of Nd₂Fe₁₄B crystal grain where Ha is not alternated, flux reversal will occur starting from a low reverse magnetic field. Accordingly, the squareness of a demagnetization curve (Hkp_{N}/HcJp_{N} where Hkp_{N} is a reverse magnetic field where remanence Mrp_{N} is 90%) will be decreased along with the addition of Dy. Here, (BH)_{maxPN} which is 1.25 MA/m or less will be constant in most cases. To the contrary, if HcJp_{N} becomes smaller, magnetic stability such as irreversible demagnetization will be generally lowered. Accordingly, HcJp_{N} according to the present invention can be defined as that a high level of HcJp_{N} is obtainable, but the level should be within a range where the (BH)_{maxPN} is not subjected to large decrease, that is, 1 to 1.25 MA/m,

Further, in the anisotropic rare earth-iron based resin bonded magnet according to the present invention, for improving irreversible demagnetization, demagnetization proof stress against reverse magnetic fields at a high temperature, or magnetic performance typically defined by a (BH)ₘₐₓ, when the coercivity of Sm₂Fe₁₇N₃ based magnetic material is HcJp_{S}, the coercivity of Nd₂Fe₁₄B based magnetic material at a room temperature is HcJp_{N}, and a ratio between HcJp_{S} and HcJp_{N} (HcJp_{S}/HcJp_{N}) is α, the following can be determined: HcJp_{N} is 1 to 1.25 MA/m while HcJp_{S} is equal to or less than HcJp_{N} (HcJp_{S}≦HcJp_{N}). Further, α should be 0.75 or less, or more preferably 0.65 or less.

In the anisotropic rare earth-iron based resin bonded magnet according to the present invention, when its remanence is Mr_{M}, the remanence of a mixture between a spherical Sm₂Fe₁₇N₃ based magnetic material (real density: 7.67 Mg/m³) and an Nd₂Fe₁₄B based magnetic material (real density: 7.55 Mg/m³) is Mrₚ, and the volume fraction of the whole magnetic material accounting for the resin bonded magnet is Vfₚ, the following can be established. That is, by setting that Vfₚ is equal to or greater than 80 vol. % (Vfₚ≧80 vol. %) and α is 0.75 or less, the orientation degree of the magnetic material Mr_{M}/(Mrₚ×Vfₚ) can be 0.96 or more while its (BH)ₘₐₓ is 170 kJ/m³ or more. Further, by setting that Vfₚ is equal to or greater than 80 vol. % (Vfₚ≧80 vol. %) and α is 0.65 or less, the orientation of the magnetic material Mr_{M}/(Mrₚ×Vfₚ) can be 0.98 or more while its (BH)ₘₐₓ is 180 kJ/m³ or more.

Further, in the anisotropic rare earth-iron based resin bonded magnet according to the present invention, in case that the squareness of a demagnetization curve at a room temperature is Hk/HcJ_{RT}, and the squareness at 100° C. is Hk/HcJ₁₀₀, it would be preferable that Hk/HcJ_{RT}<Hk/HcJ₁₀₀.

Here, considering a rotary machine that can effectively secure the magnetic stability and can employ the air-gap magnetic flux density of the anisotropic rare earth-iron based resin bonded magnet according to the present invention (that is, a magnetic circuit structure between an iron core and the magnet according to the present invention), it would be preferable that air-gap permeance coefficient Pc is 3 or more.

As discussed hereinabove, in the anisotropic rare earth-iron based resin bonded magnet according to the present invention, it is possible to obtain the following structure that coercivity HcJ at a room temperature is approximately 1 MA/m or more while the squareness of the demagnetization at a high temperature which satisfies Hk/HcJ_{RT}<HcJ₁₀₀ will not be deteriorated. Further, since a high magnetic property where the maximum energy product (BH)ₘₐₓ is 170 or 180 kJ/m³ or more is also provided, it can be regarded as the next generation type of the isotropic Nd₂Fe₁₄B based resin bonded magnet with (BH)ₘₐₓ of 80 kJ/m³ contributing to the miniaturization and the high mechanical output of the rotary machine.

### EMBODIMENTS

Hereinafter, the present invention will be explained in further details based on embodiments. The present invention is not however limited to the embodiments.

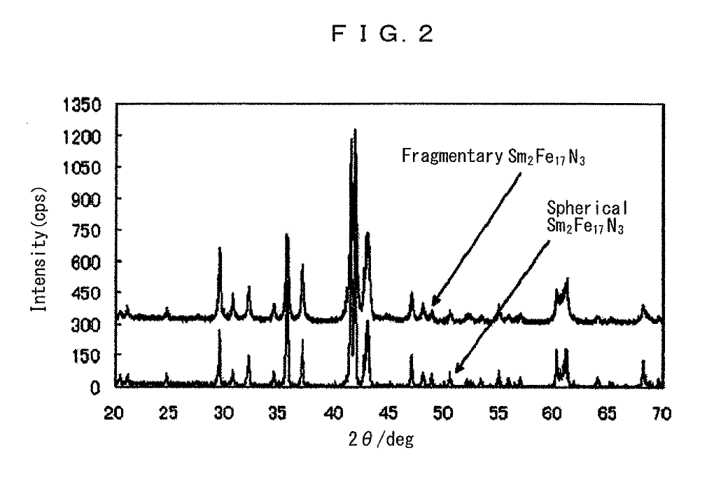

FIG. 2 is a chart indicating X-ray diffraction patterns of Sm₂Fe₁₇N₃ based magnetic materials produced without conducting mechanical milling following nitriding of an Sm—Fe alloy, and a fragmentary Sm₂Fe₁₇N₃ based magnetic material that has been milled through a jet mill following nitriding. As shown, there is no difference in both crystal structures based on a Sm₂Fe₁₇N₃ intermetallic compound.

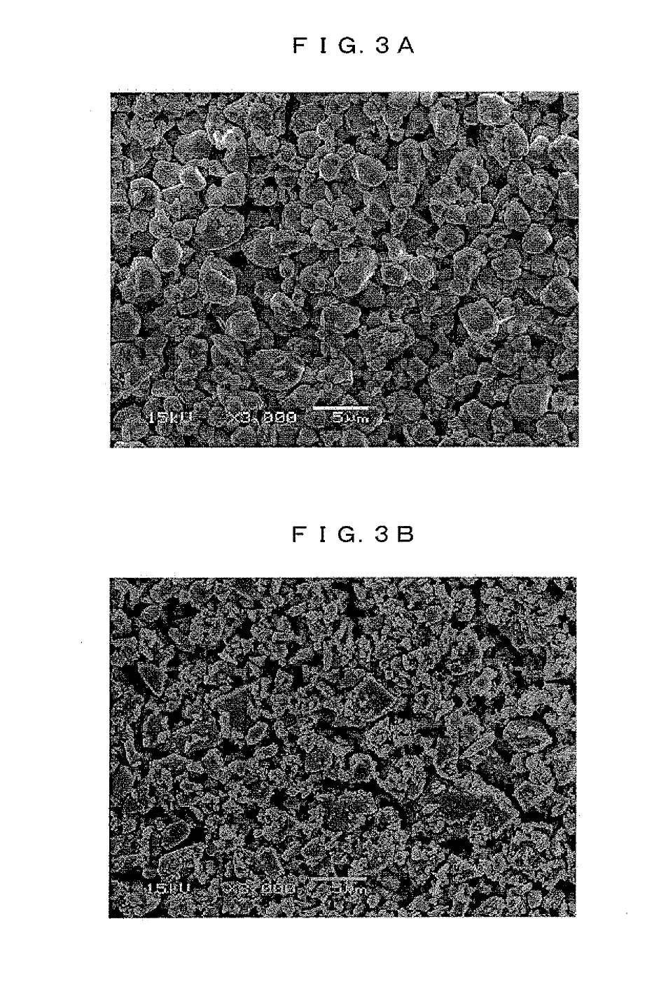

FIGS. 3A and 3B are SEM (Scanning Electron Microscope) photos indicating two kinds of magnetic materials. Considering the fragmentary Sm₂Fe₁₇N₃ based magnetic materials as shown in FIG. 3B, it is possible to observe the aggregation of micronized powder formed by milling, the micronized powder having a particle size of less than 1 μm (exclusive). On the other hand, as shown in FIG. 3A, the Sm₂Fe₁₇N₃ based magnetic material produced without mechanical milling after nitriding an Sm—Fe alloy does not contain the micronized powder having a particle size of less than 1 μm (exclusive).

As disclosed by Japanese Patent Application Laid-Open No. 2000-12316, the micronized powder discussed hereinabove will negatively influence magnetic properties such as coercivity HcJ_{S} of Sm₂Fe₁₇N₃ based magnetic materials. However, by being subjected to a temperature history of 50° C. or more that is inevitable when resin bonded magnets are formed into a specific shape, the micronized powder having a particle size of less than 1 μm (exclusive) will be disappeared. Accordingly, as to the final magnetic property of the resin bonded magnets, Sm₂Fe₁₇N₃ based magnetic materials having a particle size of 1 μm or more where their magnetic properties have not been impaired are going to take over. More specifically, the micronized powder having a particle size of less than 1 μm (exclusive) that can be observed at the fragmentary Sm₂Fe₁₇N₃ based magnetic materials as shown in FIG. 3B does not contribute to the magnetic property of the resin bonded magnet. Moreover, it will increase viscidity when dispersed in melted molecule chain of polymer and oligomer. Further, it may be possible that the aggregation force of the micronized powders interferes the orientation of the magnetic materials due to magnetic fields, whereby it would be preferable to remove the micronized powder of less than 1 μm (exclusive) from the anisotropic rare earth-iron based resin bonded magnet according to the present invention.

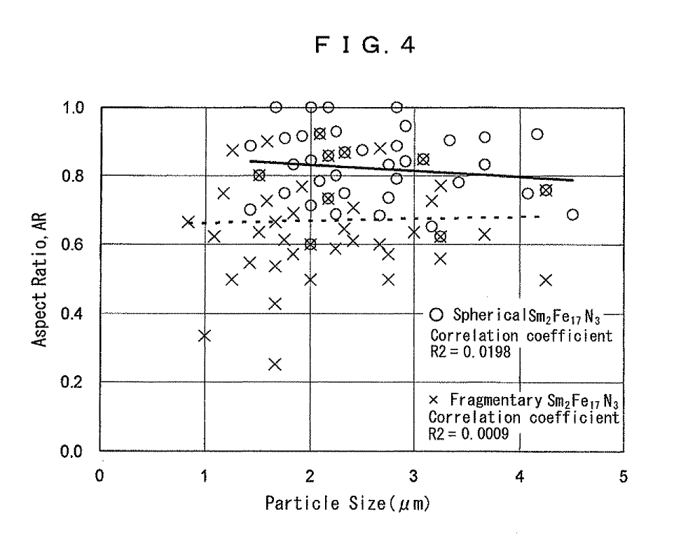

FIG. 4 is a chart indicating a relation between the particle size of Sm₂Fe₁₇N₃ based magnetic materials and an aspect ratio AR (“b/a” should be established when the maximum diameter of a particulate image is “a” while the maximum diameter perpendicular to the “a” is “b”). FIG. 4 is correspondent to FIGS. 3A and 3B. The ARₐᵥₑ of the Sm₂Fe₁₇N₃ based magnetic materials corresponding to FIG. 3A is 0.80 (Dispersion σ: 0.01) when n=50 (the minimum value is 0.6). On the other hand, the ARₐᵥₑ of the Sm₂Fe₁₇N₃ based magnetic materials corresponding to FIG. 3B is 0.67 (Dispersion a: 0.02) when n=50 (the minimum value is 0.24).

As discussed hereinabove, the Sm₂Fe₁₇N₃ based magnetic material that is applied to the anisotropic rare earth-iron based resin bonded magnet according to the present invention should be satisfied with the following condition: 1) the magnetic material should be a sphere produced without mechanical milling after the Sm—Fe alloy of FIG. 3A is nitrided; and 2) the micronized powder having a particle size of less than 1 μm (exclusive) that is inevitably produced with mechanical milling is excluded.

Here, as shown in FIG. 4, the correlation coefficient R of the aspect ratio AR relative to particle sizes of the spherical Sm₂Fe₁₇N₃ based magnetic material produced without mechanical milling after the Sm—Fe alloy is nitrided, and the fragmentary Sm₂Fe₁₇N₃ based magnetic material is both less than 0.01 (exclusive). Accordingly, the aspect ratio AR does not depend on the particle size but depends on their manufacturing processes of the magnetic materials themselves.

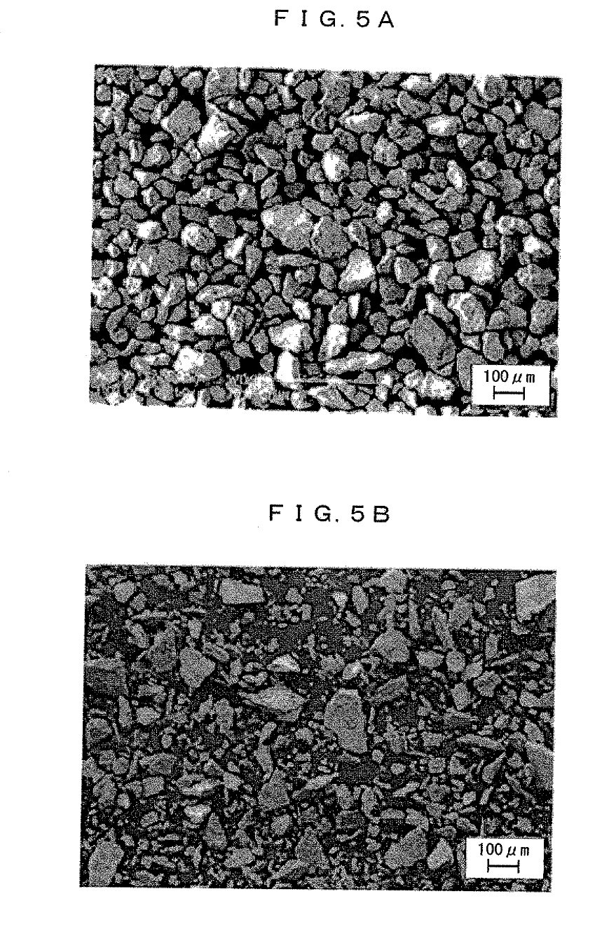

FIGS. 5A and 513 are SEM photos. FIG. 5A indicates a so-called HDDR-Nd₂Fe₁₄B based magnetic material in which hydrogen decomposition/recombination is conducted. FIG. 5B is an Nd₂Fe₁₄B based magnetic material that has been ground after hot working bulks are roughly milled with a jaw crusher. FIG. 5B shows Nd₂Fe₁₄B crystal where uniaxial compression is applied at a temperature of over the crystallization temperature of Nd₂Fe₁₄B, and observation is conducted in a direction perpendicular to a compression axial direction of bulks that are provided with anisotropic features through hot working. The Nd₂Fe₁₄B crystal is formed into flat as shown. Further, the materials that are mechanically milled also tend to be flat. The thickness direction of the materials and a C-axial direction are generally correspondent to each other. That is, the magnetic materials having a shape magnetic anisotropy perpendicular to the C-axial direction can be produced.

Considering the above magnetic material, it would be difficult to adjust to be that its average particle size is set to 50 to 150 μm while its average aspect ratio ARₐᵥₑ is set to 0.65 or more. On the other hand, the crystal of a so-called HDDR-Nd₂Fe₁₄B based magnetic material where hydrogen decomposition/recombination is performed as shown in FIG. 5A is not flat. This is due to a reason that since Nd₂Fe₁₄B crystal grain boundary is subjected to hydrogen embrittlement at the final stage of the hydrogen decomposition/recombination treatment (DR treatment) that is conducted to hot working bulks, there will be nearly no necessity for mechanical milling treatments. Therefore, it would be possible to easily obtain magnetic materials where their average particle sizes are 50 to 150 μm, and their average aspect ratios ARₐᵥₑ are 0.65 or more.

Next, through application of the Sm₂Fe₁₇N₃ based magnetic materials and the Nd₂Fe₁₄B based magnetic materials according to the present invention,

[1] a continuous phase is formed by comprising: (1) an Sm₂Fe₁₇N₃ based magnetic material that is coated with 4.5 vol. % of an o-cresol novolac epoxy oligomer where an epoxy equivalent is 205 to 220 g/eq, and a melting point is 70 to 76° C.; (2) 9.1 vol. % of a linear polymer that has an average molecular weight Mn of 4000 to 12000 and has a molecular chain amino active hydrogen making a crosslinking reaction with the oxazolidone ring of the oligomer; (3) 1.8 vol. % of a partial esterification material including pentaerythritol and higher fatty acid as internal lubricant,

[2] a discontinuous phase is coated with 2.0 vol. % of o-cresol novolac epoxy oligomer where an epoxy equivalent is 205 to 220 g/eq, and a melting point is 70 to 76° C., and

[3] the continuous phase is melted and mixed by means of an 8-inch mixing roll mill (a rotational speed: 12 rpm and a temperature: 140° C.). Further, the discontinuous phase will be added thereinto so as to produce melted/mixed materials comprising the continuous and discontinuous phases.

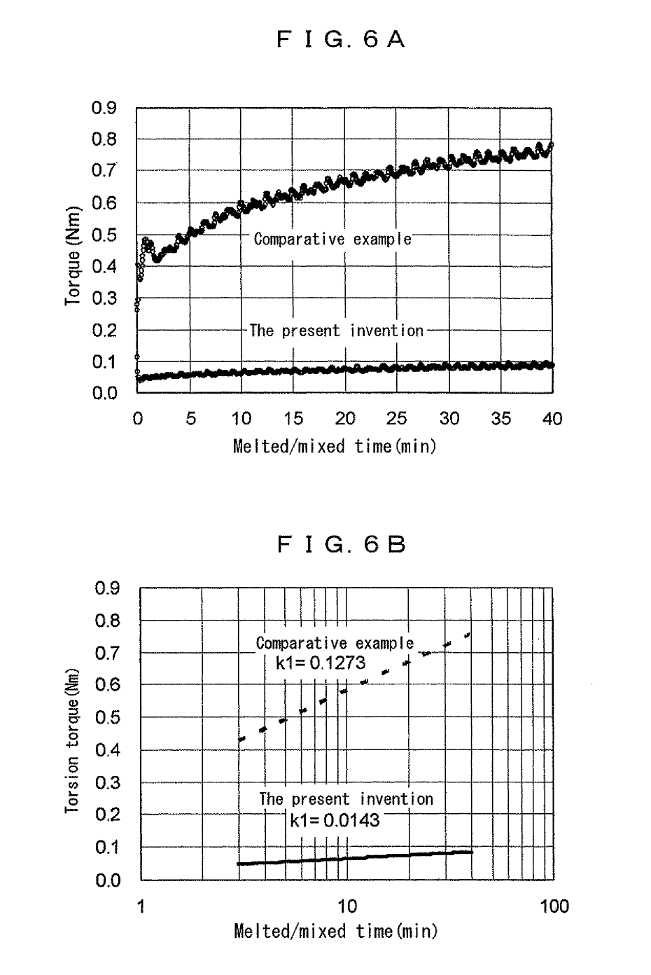

FIG. 6A indicates a torsion torque behavior where 17.5 g of the above mentioned melted/mixed materials are directly measured with a curelastmeter in a condition that a pressure is 98 kN and an oscillating angle is ±0.5 degree. Further, FIG. 6B determines an inclination that is correspondent to the first reaction rate constant K supposing that the rise of torque in FIG. 6A is the ring opening reaction (the first reaction) of the oxazolidone ring due to the amino active hydrogen (—NHCO—) of the linear polymer. As obvious, compared to the melted/mixed materials including the spherical Sm₂Fe₁₇N₃ based magnetic material of FIG. 103A according to the present invention, the melted/mixed materials including the fragmentary Sm₂Fe₁₇N₃ based magnetic material as shown in FIG. 3B has a reaction speed that is one digit larger than the spherical Sm₂Fe₁₇N₃ based magnetic material. This is why, even though they have an identical particle size, the fragmentary Sm₂Fe₁₇N₃ based magnetic material has an average aspect ratio ARₐᵥₑ smaller than the one of the spherical Sm₂Fe₁₇N₃ based magnetic material. Further, the fragmentary Sm₂Fe₁₇N₃ based magnetic material contains micronized powder. This is due to the large specific surface area of the magnetic materials. Here, the reaction velocity fixed number of this system is based on a reaction between epoxy oligomer that coats Sm₂Fe₁₇N₃ based magnetic material and the amino active hydrogen of a linear polymer. Accordingly, the concentration of a reaction substrate depends on the specific surface area of the Sm₂Fe₁₇N₃ based magnetic materials.

As discussed hereinabove, considering chemical stabilities of the melted/mixed treatments, it would be preferable that the spherical Sm₂Fe₁₇N₃ based magnetic materials according to the present invention as shown in FIG. 3A are included. Here, based an Archimedian method, the density of the melted/mixed materials is 6.1 Mg/m³ while its air-gap ratio is less than 5% (exclusive).

Next, the melted/mixed materials are cooled off up to a room temperature, and then shredded and classified with a general method so as to obtain a granular compound having a particle size of 1 mm or less. Further, as the crosslinking agent of the micronized powder, 1.8 vol. % of imidazole adduct (2-phenyl-4,5-dihydroxymethylimidazole) with an average particle size of 4 μm and thermal decomposition temperature of 230° C. is adhered on the surface of the granular compound through a dry-mixing process with a V-blender. With these processes, a composition according to the present invention can be obtained. Here, the volume fraction of the whole magnetic materials accounting for the composition will be 80.7 vol. %. Further, when removing internal lubricant that is eluted from the continuous phase to the system during magnetic field formation, the volume fraction of the whole magnetic materials accounting for the resin bonded magnet will be 82.7 vol. %. Note that this value will be a level in which to exceed the volume fraction 80 vol. % of the magnetic material of an isotropic Nd₂Fe₁₄B based resin bonded magnet with a density of 6 Mg/m³.

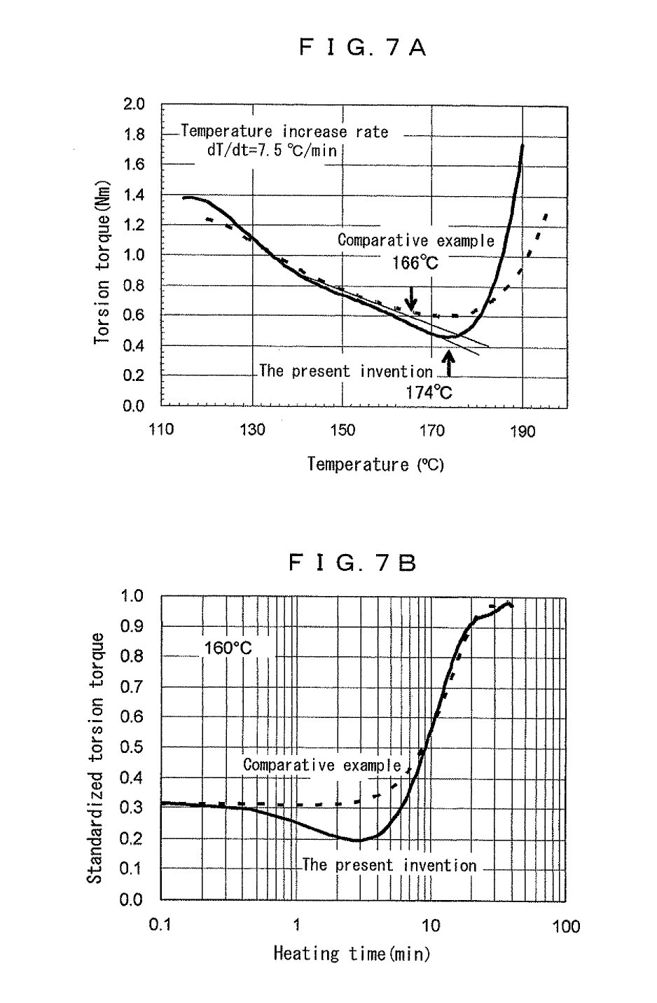

Through the application of a curelastmeter, FIG. 7A indicates torsion torque behaviors based on a temperature where the above composition according to the present invention is subjected to constant temperature rise from 110° C. to 195° C. (dT/dt=7.5° C./min) when a pressure is 98 kN, and an oscillating angle is ±0.5 degree. According to FIG. 7A, the temperature which the torsion torque increases due to crosslinking reaction of the composition is: 1) 174° C. in case of a composition including the spherical Sm₂Fe₁₇N₃ based magnetic material according to the present invention as shown in FIG. 3A; and 2) 166° C. in case of a composition including the fragmentary Sm₂Fe₁₇N₃ based magnetic material as shown in FIG. 3B. Based on the above, considering the gelation of the compositions, it is possible to observe the accelerated effects of the crosslinking reaction due to micronized powder with a particle size of less than 1 μm (exclusive). In addition, considering a temperature where the composition is formed through a magnetic field press, it would be preferable to be more than 160° C. or more but less than a temperature where the torsion torque increases due to the crosslinking reaction.

FIG. 7B indicates torsion torque variations based on the crosslinking reaction when composition is formed through the magnetic field press at a temperature of 160° C. As shown in the FIG., in case that the compositions include the spherical Sm₂Fe₁₇N₃ based magnetic material according to the present invention as shown in FIG. 3A, plasticization will be advanced right before gelation due to an external force (torsion). Accordingly, the torsion torque will be once decreased. However, considering the compositions including the fragmentary Sm₂Fe₁₇N₃ based magnetic materials as shown in FIG. 3B, the decrease of torque, that is, the plasticization of the system can not be observed. This suggests that micronized powder with a particle size of less than 1 μm will influence on magnetic orientation.

Next, the compositions according to the present invention are formed into 7×7 mm cube through the magnetic field press in a condition that a temperature is 160° C., an orthogonal magnetic field is 1.4 MA/m or more, and a pressure is less than 50 MPa (inclusive). Accordingly, anisotropic rare earth-iron based resin bonded magnets according to the present invention and comparative examples are obtained. Here, the composition according to the present invention is precedently adjusted to have the density of 6 Mg/m³ or more in a melted/mixed condition. By rearranging magnetic materials by means of external magnetic fields in a condition that a linear polymer is melted in a molding cavity, it would be possible to re-obtain the density of 6 Mg/m³ or more even with a lower pressure of 50 MPa.

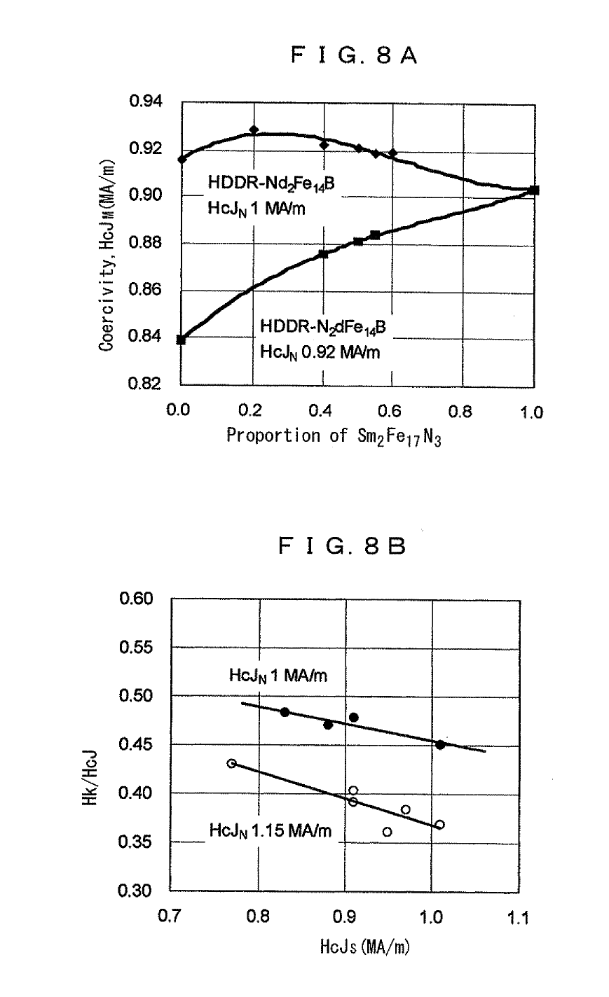

FIG. 8A is a chart indicating coercivity HcJ_{M} of the resin bonded magnets when changing the proportion of the coercivity HcJp_{S} of the spherical Sm₂Fe₁₇N₃ based magnetic materials (0.92 MA/m). Here, the coercivity HcJp_{N} of Nd₂Fe₁₄B based magnetic materials at a room temperature is set to 1 MA/m and 0.92 MA/m. As clearly shown in the FIG., when the HcJp_{N} reaches the lower bound of the present invention or 1 MA/m while HcJp_{S} is equal to or less than HcJp_{N} (HcJp_{S}≦HcJp_{N}), a notable decrease of the HcJ_{M} can not be observed. However, when HcJp_{N} is equal to HcJp_{S} (HcJp_{N}=HcJp_{S}), the HcJ_{M} will be decreased in proportion to the ratio of the spherical Sm₂Fe₁₇N₃ based magnetic material. This means that magnetic stabilities represented by irreversible demagnetization are decreased.

Next, FIG. 8B is a chart indicating the relation of squareness Hk/HcJ of a demagnetization curve at a room temperature in case that HcJp_{N} is 1 and 1.15 MA/m where the coercivity HcJp_{N} of the Nd₂Fe₁₄B based magnetic material is HcJp_{N}, and the coercivity of the spherical Sm₂Fe₁₇N₃ based magnetic material is HcJp_{S}. However, this magnetic property has been measured through a B—H tracer (Measuring magnetic fields Hm: ±2.4 MA/m) subjected to 7 mm cubed sample. When considering an Nd₂Fe₁₄B based magnetic material where its total weight satisfies HcJp_{N}=1.15 MA/m (HcJp_{N} is equal to 1.15 MA/m), Hk/HcJ is defined by 0.31. Accordingly, in the anisotropic rare earth-iron based resin bonded magnet according to the present invention where HcJp_{N} is equal to or greater than HcJp_{S} (HcJp_{N}≧HcJp_{S}), it is possible to improve Hk/HcJ of the Nd₂Fe₁₄B based resin bonded magnet.

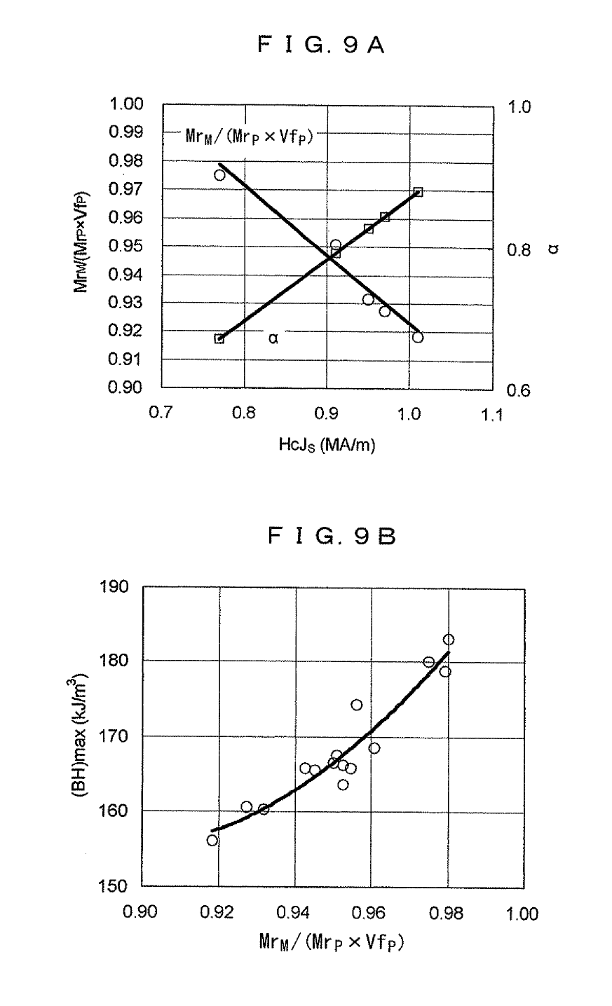

FIG. 9A indicates a relation between the orientation degree of magnetic materials Mr_{M}/(Mrₚ×Vfₚ) relative to HcJp_{S} when Vfₚ is equal to or greater than 80.7 vol.% (Vfₚ≧80.7 vol. %) and α. On the other hand, FIG. 9B indicates a relation between the orientation degree of magnetic materials Mr_{M}/(Mrₚ×Vfₚ) and a (BH)ₘₐₓ of a resin bonded magnet. Here, those FIGS. satisfy the following condition: the coercivity of Nd₂Fe₁₄B based magnetic materials at a room temperature is HcJp_{N}; the coercivity of spherical Sm₂Fe₁₇N₃ based magnetic materials is HcJp_{S}; a ratio between HcJp_{S} and HcJp_{N} (HcJp_{S}/HcJp_{N}) is a; the remanence of a resin bonded magnet is Mr_{M}; the remanence of a compound based on the spherical Sm₂Fe₁₇N₃ and the Nd₂Fe₁₄B based magnetic materials is Mrₚ; the volume fraction of the whole magnetic materials accounting for the resin bonded magnet is Vfₚ; and the orientation degree of the whole magnetic materials in the resin bonded magnet is Mr_{M}/(Mrₚ×Vfₚ).

Based on FIG. 9A and FIG. 98, when α is approximately set to 0.75, Mr_{M}/(Mrₚ×Vfₚ) becomes 0.96 whereby the (BH)ₘₐₓ of the anisotropic rare earth-iron based resin bonded magnet according to the present invention exceeds 170 kJ/m³. Further, when α is approximately set to 0.65, Mr_{M}/(Mrₚ×Vfₚ) becomes approximately 0.98 whereby the (BH)ₘₐₓ according to the present invention reaches to 180 kJ/m³.

As discussed hereinabove, in the present invention, when the coercivity of the Nd₂Fe₁₄B based magnetic material at a room temperature is HcJp_{N}, and the coercivity of the spherical Sm₂Fe₁₇N₃ based magnetic material is HcJp_{S}, it would be necessary to satisfy that HcJp_{N} is equal to or greater than HcJp_{S}. In addition, more preferably, when a ratio between HcJp_{S} and HcJp_{N} (HcJp_{S}/HcJp_{N}) is α, α is set to 0.75 or 0.65. Accordingly, when the remanence of the resin bonded magnet is Mr_{M}, the remanence of a compound including the spherical Sm₂Fe₁₇N₃ based magnetic material and the Nd₂Fe₁₄B based magnetic material is Mrₚ, and the volume fraction of the whole magnetic material accounting for the resin bonded magnet is Vfₚ, Vfₚ is equal to or greater than 80 vol. %, and when α is 0.75 or 0.65, the orientation degree of the whole magnetic material Mr_{M}/(Mrₚ×Vfₚ) becomes 0.96 or 0.98, respectively. Accordingly, the present invention can provide the anisotropic rare earth-iron based resin bonded magnet where the magnetic material is highly oriented.

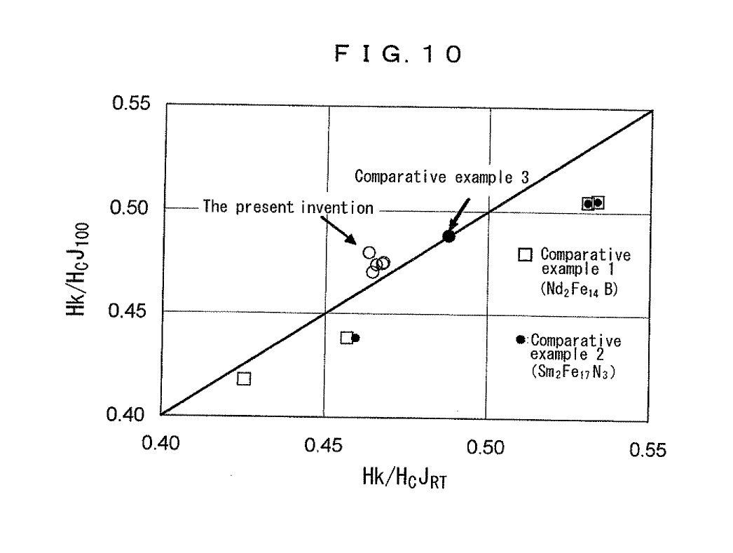

In FIG. 10, the coercivity HcJp_{N} of the Nd₂Fe₁₄B based magnetic material at a room temperature and the coercivity HcJp_{S} of the spherical Sm₂Fe₁₇N₃ based magnetic material are both set to 1 MA/m. Further, the squareness of a demagnetization curve of the anisotropic rare earth-iron based resin bonded magnet at a room temperature according to the present invention is set to Hk/HcJ_{RT}, and a squareness at a temperature of 100° C. is set to Hk/HcJ₁₀₀. Based on the above condition, a relation between the Hk/HcJ_{RT} and Hk/HcJ₁₀₀ is shown in the FIG. 10. Here, a diagonal line in the FIG. indicates that Hk/HcJ_{RT} and Hk/KcJ₁₀₀ are equal to each other. As clearly shown in FIG. 10, a comparative example 1 (Nd₂Fe₁₄B based resin bonded magnet) and a comparative example 2 (Sm₂Fe₁₇N₃ based resin bonded magnet) both satisfy that Hk/HcJ_{RT} is greater than Hk/HcJ₁₀₀(Hk/HcJ_{RT}> Hk/HcJ₁₀₀). On the other hand, the anisotropic rare earth-iron based resin bonded magnet satisfies that Hk/HcJ_{RT} is less than Hk/HcJ₁₀₀ (Hk/HcJ_{RT}<Hk/HcJ₁₀₀). Further, a comparative example 3 indicates the features of an anisotropic rare earth-iron based resin bonded magnet where fragmentary Sm₂Fe₁₇N₃ based magnetic materials including micronized powder as shown in FIG. 3B are applied. As shown in FIG. 10, Hk/HcJ_{RT} and Hk/HcJ₁₀₀ are both defined by 0.487, or Hk/HcJ_{RT} and Hk/HcJ₁₀₀ are nearly equal to each other (Hk/HcJ_{RT}≈Hk/HcJ₁₀₀). Further, there is also a case that Hk/HcJ₁₀₀ is slightly lower than Hk/HcJ_{RT}.

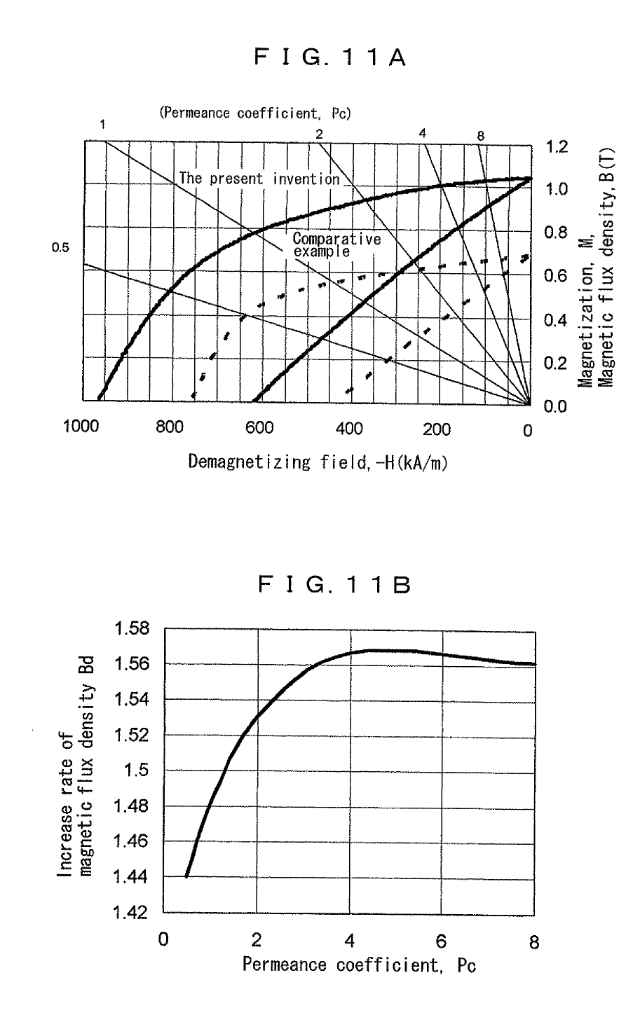

In FIG. 11A, the demagnetization curve of an anisotropic rare earth-iron based resin bonded magnet according to the present invention is comparatively shown with the demagnetization curve of an isotropic Nd₂Fe₁₄B based resin bonded magnet (a comparative example). Here, in the anisotropic rare earth-iron based resin bonded magnet according to the present invention, its coercivity HcJ is 0.97 MA/m, its remanence Mr is 1.05 T, and its (BH)ₘₐₓ is 179 kJ/m³. On the other hand, in the isotropic Nd₂Fe₁₄B based resin bonded magnet as the comparative example, its HcJ is 0.72 MA/m, Mr is 0.70 T, and its (BH)ₘₐₓ is 79.7 kJ/m³. Moreover, FIG. 11B indicates permeance dependency as to the increase rate of magnetic flux density in connection with the anisotropic rare earth-iron based resin bonded magnet according to the present invention and the isotropic Nd₂Fe₁₄B based resin bonded magnet. As clearly shown in FIG. 11B, in order to establish rotary machines that can effectively secure the magnetic stability of the anisotropic rare earth-iron based resin bonded magnet according to the present invention, or to further improve the increase rate of an air-gap magnetic flux density for the rotary machines comprising an iron core and a magnetic circuit, it would be preferable that its permeance coefficient is Pc 3 or more.

As discussed hereinabove, in the anisotropic rare earth-iron based resin bonded magnet according to the present invention, it is possible that its coercivity HcJ at a room temperature is approximately 1 MA/m, and that the squareness of a high-temperature demagnetization curve (Hk/HcJ_{RT}<Hk/HcJ₁₀₀) is not deteriorated. Moreover, since high magnetic properties are obtainable (the maximum energy product (BH)ₘₐₓ is 170, 180 kJ/m³ or more), it can be the next generation type of isotropic Nd₂Fe₁₄B based resin bonded magnets with (BH)ₘₐₓ of 80 kJ/m³ thereby contributing to miniaturization and a high mechanical output of the rotary machines.

1. An anisotropic rare earth-iron based resin bonded magnet comprising:
[1] a continuous phase including: (1) a spherical Sm₂Fe₁₇N₃ based magnetic material where its average particle size is 1 to 10 μm, its average aspect ratio ARₐᵥₑ is 0.8 or more in a condition that AR is b/a when the maximum diameter of a particulate picture is “a” while the maximum diameter perpendicular to the “a” is “b”, and mechanical milling is not applied after an Sm—Fe alloy is nitrided, the spherical Sm₂Fe₃₇N₃ based magnetic material being covered with epoxy oligomer that is solid at a room temperature; (2) a linear polymer that has an active hydrogen group in which to react to the oligomer; and (3) an additive to be added in when necessary; and
[2] a discontinuous phase being defined by an Nd₂Fe₁₄B based magnetic material where its average particle size is 50 to 150 μm, and its average aspect ratio ARₐᵥₑ is 0.65 or more, the Nd₂Fe₁₄B based magnetic material being covered with epoxy oligomer that is solid at a room temperature, the anisotropic rare earth-iron based resin bonded magnet further satisfying the following:
[3] an air-gap ratio of a granular compound on the continuous and discontinuous phases is 5% or less; and
[4] a composition where a crosslinking agent having an average particle size of 10 μm or less is adhered on a surface of the granular compound is formed into a predetermined shape through a magnetic field press at 50 MPa or less.

2. The anisotropic rare earth-iron based resin bonded magnet according to claim 1, wherein HcJp_{N} is 1 to 1.25 MA/m while HcJp_{S} is equal to or less than HcJp_{N} when coercivity of the spherical Sm₂Fe₁₇N₃ based magnetic material is HcJp_{S}, and coercivity of the Nd₂Fe₁₄B based magnetic material at a room temperature is HcJp_{N}.

3. The anisotropic rare earth-iron based resin bonded magnet according to claim 1 wherein HcJp_{N} is 1 to 1.25 MA/m while α is 0.75 or less when coercivity of the spherical Sm₂Fe₁₇N₃ based magnetic material is HcJp_{S}, coercivity of the Nd₂Fe₁₄B based magnetic material at a room temperature is HcJp_{N}, and a ratio between HcJp_{S} and HcJp_{N} (HcJp_{S}/HcJp_{N}) is α.

4. The anisotropic rare earth-iron based resin bonded magnet according to claim 1, wherein HcJp_{N} is 1 to 1.25 MA/m while α is 0.65 or less when coercivity of the spherical Sm₂Fe₁₇N₃ based magnetic material is HcJp_{S}, coercivity of the Nd₂Fe₁₄B based magnetic material at a room temperature is HcJp_{N}, and a ratio between HcJp_{S} and HcJp_{N} (HcJp_{S}/HcJp_{N}) is α.

5. The anisotropic rare earth-iron based resin bonded magnet according to claim 1, wherein Vfₚ is equal to or larger than 80 vol. % while an orientation degree of the magnetic material Mr_{M}/(Mrₚ×Vfₚ) is 0.96 or more when remanence of the resin bonded magnet is Mr_{M}, remanence of the spherical Sm₂Fe₁₇N₃ and the Nd₂Fe₁₄B based magnetic material is Mrₚ, and a volume fraction of the whole magnetic material accounting for the resin bonded magnet is Vfₚ.

6. The anisotropic rare earth-iron based resin bonded magnet according to claim 1, wherein the maximum energy product (BH)ₘₐₓ at a room temperature is 170 kJ/m³ or more.

7. The anisotropic rare earth-iron based resin bonded magnet according to claim 1, wherein Vfₚ is equal to or larger than 80 vol. % while an orientation degree of the magnetic material Mr_{M}/(Mrₚ×Vfₚ) is 0.98 or more when remanence of the resin bonded magnet is Mr_{M}, remanence of a compound including the spherical Sm₂Fe₁₇N₃ based magnetic material and the Nd₂Fe₁₄B based magnetic material is Mrₚ, and a volume fraction of the whole magnetic material accounting for the resin bonded magnet is Vfₚ.

8. The anisotropic rare earth-iron based resin bonded magnet according to claim 1, wherein the maximum energy product (BH)ₘₐₓ at a room temperature is 180 kJ/m³ or more.

9. The anisotropic rare earth-iron based resin bonded magnet according to claim 1, wherein Hk/HcJ_{RT} is less than Hk/HcJ₁₀₀ when a squareness at a room temperature is Hk/HcJ_{RT}, and a squareness at a temperature of 100° C. is Hk/HcJ₁₀₀.

10. The anisotropic rare earth-iron based resin bonded magnet according to claim 1, wherein the anisotropic rare earth-iron based resin bonded magnet is formed into an annular configuration such as an arc shape or a cylindrical shape and has at least one pair of poles, and wherein a magnetic circuit with an iron core is constructed as that permeance coefficient Pc is 3 or more.
